(19) United States
(12) Patent Application Publication
(10) Pub. No.: US 2006/0278717 A1
(43) Pub. Date: Dec. 14, 2006

(54) Media identifying, tracking, and cataloging systems and methods

(76) Inventors: Henning W. VonKlinggraeff, Richfield, MN (US); Charles E. Boyer, Lake Elmo, MN (US)

Correspondence Address: Mark Binder;Kagan Binder PLLC, 221 Main St N Ste 200, Stillwater, MN, 55082, US

(21) Appl. No.: 11/352,414

(22) Filed: Feb. 9, 2006

Related U.S. Application Data
(60) Provisional application No. 60/651,913, filed on Feb. 9, 2005.

(51) Int. Cl. G06K 19/00; G06K 19/06

(52) U.S. Cl. 235/487; 235/494

(57) ABSTRACT

An identification label that can be used to identify an individual media element within a media collection comprising a plurality of medial elements is provided. The identification label comprises a label surface having a two-dimensional symbol provided on the label surface and an attachment surface that can be used to attach the label to a media element of a media collection. The two-dimensional symbol comprises encoded information that can be used to identify the medial element within the media collection and may include additional information as desired. Also, a method of identifying an individual media element within a media collection is provided. The method comprises the steps of associating a predetermined media element of a media collection comprising a plurality of media elements with a two-dimensional symbol and displaying the two-dimensional symbol on a portion of the predetermined media element.

### REFERENCE TO RELATED APPLICATIONS

This application claims the benefit of U.S. Provisional application Ser. No. 60/651,913, filed Feb. 9, 2005, entitled, “MEDIA IDENTIFYING, TRACKING, AND CATALOGING SYSTEMS AND METHODS,” which application is incorporated herein by reference in its entirety.

### TECHNICAL FIELD

The present disclosure relates to methods and systems for identifying, tracking, and cataloging media. More particularly, the present disclosure relates to identifying, tracking, and cataloging media collections such as those comprising books, magazines, compact disks, video disks, and the like by using two-dimensional matrix coding technology.

### BACKGROUND

Media collections, such as those found in a library, for example, are frequently voluminous. These collections can include a variety of different types of media such as books, magazines, audio media such as compacts disks and tapes, video media such as digital videodisks, and the like. Because of the large volume of such media collections, identifying and cataloging techniques are frequently used to manage and control media collections. Moreover, because institutions such as libraries loan media to members, security and tracking techniques are also often used.

One common way to identify, catalog, and track a large media collection is to use a one-dimensional barcode. The barcode typically represents an alphanumeric code that uniquely identifies the media. The alphanumeric code is recorded in a database or the like and used for cataloging purposes. In the case of a book, for example, the one-dimensional barcode is physically attached to the book and can be optically scanned to quickly identify the book. Additionally, using a one-dimensional barcode in this way also allows for easy tracking of such media. The one-dimensional barcode can be scanned to electronically checkout a book or the like when it is loaned from a library and similarly scanned to electronically check the book back in when it is returned.

There are some limitations to using such one-dimensional barcodes for identifying, cataloging, and tracking media collections, however. In the case of a book, for example, one-dimensional barcodes are typically placed on either the front or rear cover of the book, or both, instead of the spine of the book. This is because one-dimensional barcodes do not fit well on the spine of a book, as they tend to be somewhat large. Placing the one-dimensional barcode on the spine of the book can undesirably cover information that is present on the spine of the book. This can make it difficult to quickly scan the one-dimensional barcode of a book stored on a shelf because only the spine of a book is optically accessible when stored this way. One-dimensional barcodes are limited in the amount of information that can be coded in a one-dimensional barcode and the size of the one-dimensional barcode generally increases as the amount of information coded in the one-dimensional barcode increases. Moreover, barcodes can be difficult to accurately read when they are provided on uneven or non-flat surface such as may be present on the spine of a book. With regard to other types of media, the same limitations often apply, particularly those limitations related to the physical space needed for a one-dimensional barcode and the amount of information that a one-dimensional barcode can contain.

### SUMMARY OF THE INVENTION

The present invention overcomes the limitations of one-dimensional barcodes described above by using area symbology techniques for identifying, cataloging, tracking, or otherwise managing media collections. Area symbologies, such as those commercially known under the trade names Vericode™ or Data Matrix™ or Code One™ are well known two-dimensional symbologies. A two-dimensional symbology typically includes a matrix in the form of a symbol that occupies a uniform amount of space having a generally rectangular or square shape. Instead of bars and spaces, as used in one-dimensional barcodes, round or square marks disposed at particular rows and columns of the matrix correspond to the information being conveyed.

One advantage that two-dimensional symbols have over one-dimensional barcodes is that a two-dimensional symbol can include significantly more data within a given volume of space than a conventional one-dimensional barcode. Moreover, many two-dimensional symbols can be scaled to small sizes, allowing convenient usage on a variety of media types such as on small book spines, for example. Two-dimensional symbols are also omni-directional thereby eliminating the need to be aligned to a scanner or reading device in a predetermined way as with one-dimensional barcodes. Typical libraries use a Session Initiation Protocol (SIP) to manage all information related to medial collections. This protocol enables multi-user sessions regardless of media content and is now a specification of the Internet Engineering Task Force (IETF). Because of this, the need and usage of more information in the code is often not needed. This allows a two-dimensional symbol to be reduced in size even further and still be read with a suitable scanner or reading device.

By being able to place an identifying symbol such as a Vericode symbol for example on the spine of a book or on other types of media where a one-dimensional barcode will not conveniently fit, improved inventory practices can be realized. Because the two-dimensional symbol is a visual technology, the person performing the inventory will know exactly how many books were scanned along with the order in which they were scanned. In this way, an accurate shelf order for a collection of books can be provided. This is difficult to do with other techniques such as those that use RFID techniques. An RFID system can obtain a signal from a plurality of books and recognize the presence of the books but cannot determine any spatial information about the books unless they are scanned one at a time. This can be difficult to do because RFID systems can detect books within a large area.

In one aspect of the present invention, a method of identifying an individual media element within a media collection is provided. The method comprises the steps of associating a predetermined media element of a media collection comprising a plurality of media elements with a two-dimensional symbol and displaying the two-dimensional symbol on a portion of the predetermined media element.

In another aspect of the present invention an identification label that can be used to identify an individual media element within a media collection comprising a plurality of medial elements is provided. The identification label comprises a label surface having a two-dimensional symbol provided on the label surface and an attachment surface that can be used to attach the label to a media element of a media collection. The two-dimensional symbol comprises encoded information that can be used to identify the medial element within the media collection and may include additional information as desired.

### BRIEF DESCRIPTION OF THE DRAWINGS

The accompanying drawing, which is incorporated in and constitutes a part of this application, illustrates several aspects of the invention and together with description of the embodiments serves to explain the principles of the invention. A brief description of the drawing is as follows:

FIG. 1 is an exemplary label that includes plural two-dimensional optically readable symbols in accordance with the present invention. The illustrated label can be attached to a book or other form of media for providing an identifying, tracking, and/or cataloging capability.

### DETAILED DESCRIPTION

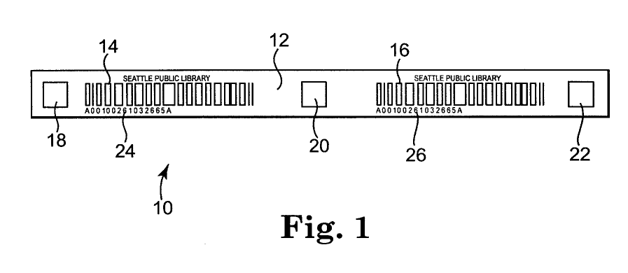

Referring to FIG. 1, an exemplary label 10 in accordance with one aspect of the present invention is shown. As described in more detail below, the label 10 can be used to provide identifying, tracking, and/or cataloging capabilities for one or more media elements of a media collection containing a plurality of media elements. Such media elements may include books, magazines, compact disks, videotapes and disks, and the like.

As illustrated, the label 10 includes a face 12 that includes a plurality of optically readable symbols provided thereon. In particular, the exemplary label 10, as illustrated, includes two one-dimensional barcodes, 14 and 16, respectively, and three two-dimensional symbols, 18, 20, and 22, respectively. The illustrated label 10 is designed for use with a book and can be designed for use with other forms of media in accordance with the present invention. For use with a book (not shown), the one-dimensional barcodes, 14 and 16, and two-dimensional symbols, 18, 20, and 22 are preferably positioned on the label 10 to be spaced apart from each other so that when the label 10 is affixed to a book, the barcodes and two-dimensional symbols are positioned in predetermined locations on the book. In particular, the one-dimensional barcode 16 and the two-dimensional symbol 22 are preferably located on the front cover of the book, the one-dimensional barcode 14 and the and two-dimensional symbol 18 are preferably located on the rear cover of the book, and the two-dimensional symbol 20 is preferably located on the spine of the book. This can be accomplished by wrapping the label 10 around the spine portion of the book.

The one-dimensional barcodes, 14 and 16, and two-dimensional symbols, 18, 20, and 22 preferably contain information related to the book (or other media) on which they are provided. In the case of a book, the one-dimensional barcodes, 14 and 16, preferably represent an identification code or number for the book. Preferably, the barcodes, 14 and 16, represent the same information but can represent different information. This code can be used to identify, track, and/or catalog the book within a database or the like. Preferably, as shown, a human readable form of the code is also provided on the label 10. In particular, barcode 14 includes human readable code 24 and barcode 16 includes human readable code 26. These human readable codes allow someone without a barcode scanner to visually identify the book. Preferably, the two-dimensional symbols, 18, 20, and 22 contain at least the same information as the one-dimensional barcodes, 14 and 16, and may contain additional information. For example, the two-dimensional symbols, 18, 20, and 22 may include information such as a title, author, abstract, or related works for a particular book or other similar information for other media.

The one-dimensional barcodes, 14 and 16, and two-dimensional symbols, 18, 20, and 22 can be provided in any desired way and do not need to be provided as a single label as illustrated in the exemplary label 10. Individual labels may be used for each barcode/symbol or groups of barcodes/symbols. Preferably, labels are used but any other manner of providing a barcode or two-dimensional symbol on media may be used such as by directly printing the barcode or two-dimensional symbol on the media or by providing the barcode or two-dimensional symbol on a cover or sleeve or the like that allows integration of the barcode or two-dimensional symbol with the media. Any number of two-dimensional symbols may be used. Use of one-dimensional barcodes together with two-dimensional symbols is optional and contemplated in accordance with the present invention.

Organizations, such as libraries, for example, that have large media collections with a plurality of media elements (a collection of books, for example) typically use one-dimensional barcodes to identify each media element in a collection. These barcodes are typically provided on the front and rear covers of the books and are optically scanned for tracking and identifying purposes. However, as discussed above, such one-dimensional barcodes are difficult to provide on the spine of a book (or on other media without a suitable space for a one-dimensional barcode) making it difficult to identify shelved books.

In accordance with the present invention, one-dimensional barcodes, typically used with media collections, can be replaced or supplemented with two-dimensional symbols such as by using the label 10 described above. By using two-dimensional symbols in accordance with the present invention, the limitations of the one-dimensional barcodes can be overcome. In particular, more information can be provided by a two-dimensional symbol, a two-dimensional symbol can be used on media in locations where one-dimensional barcodes do not work, and two-dimensional symbols can provide enhanced security features as compared to one-dimensional barcodes.

In one aspect of the present invention, the use of two-dimensional symbols can be easily implemented with a large media collection, such as a collection of books that already uses one-dimensional barcodes. The one-dimensional barcode of a book can be scanned with a reading device to obtain the information in the one-dimensional barcode. The reading device can output the information to a system capable of encoding the information into a two-dimensional symbol. A label, such as the label 10, can be printed and attached to the book. In this way, the book can still have the one-dimensional barcode together with the two-dimensional symbol thus making the transition to use of two-dimensional symbols easier and more convenient. If desired, additional information can be encoded within the two-dimensional symbol at this time.

By utilizing two-dimensional symbol technology in accordance with the present invention, plural functions can be performed for managing media collections including inventory, lost/stolen/misplaced and tracking. It is contemplated that the present invention may be used together with automated conveyor systems that have integrated sorting systems that utilize information obtained from a barcode. Such systems can be used to obtain information from a two-dimensional symbol in accordance with the present invention. For example, systems such as the Tech-Logic automated sorting system can be used.

The following features for a label such as the label 10 are preferred but not required:

Two identical CODABAR barcodes and three VERICODE dot codes per label.
Thermal transfer printed.
Permanent pressure sensitive adhesive, 3M (or equivalent), 2 mil.
Mat finish laminated.
Sequentially numbered.
Sheet format in packages not to exceed 35 pounds.
Ability to withstand 150 cycles of the Taber Abrasion Test before image quality is substantially affected.
Ability to withstand 7,500 cycles of the Sutherland Rub Test with minimal reduction in scannability.
   Exemplary CODABAR specifications include:
CODABAR format barcode with human readable number below, 10 CPI
Imprinted above the barcode with library's name.
Code height of 0.320 inches.
Minimum border at each end is 0.02 inches.
Bar definition greater than 0.001 inches.
Print contrast at least 90%.
   Exemplary VERICODE Specifications include:
Dot code structure to be 18 by 18 cells.
Height and width of dot code 0.36 inches minimum not to exceed 0.54 inches.
Dot size 0.02 inches minimum not to exceed 0.03 inches.
Dot code contents to contain Library name and sequential number
Start and stop codes not necessary for dot code

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. A method of identifying an individual media element within a media collection, the method comprising the steps of:
associating a predetermined media element of a media collection comprising a plurality of media elements with a two-dimensional symbol; and
displaying the two-dimensional symbol on a portion of the predetermined media element.

2. The method of claim 1, wherein the predetermined media element comprises a book.

3. The method of claim 2, wherein the two-dimensional symbol is provided on a spine portion of the book.

4. The method of claim 1, wherein the step of displaying the two-dimensional symbol comprises providing the two-dimensional symbol on a label and attaching the label to the portion of the predetermined media element.

5. The method of claim 1, further comprising the step of associating the predetermined media element with a one-dimensional barcode wherein at least a portion of the information encoded in the one-dimensional barcode is encoded in the two-dimensional symbol.

6. An identification label that can be used to identify an individual media element within a media collection comprising a plurality of medial elements, the identification label comprising a label surface having a two-dimensional symbol provided on the label surface and an attachment surface that can be used to attach the label to a media element of a media collection, wherein the two-dimensional symbol comprises encoded information that can be used to identify the medial element within the media collection.

7. The identification label of claim 6, wherein the two-dimensional symbol comprises a Vericode symbol.

8. The identification label of claim 6, further comprising a one-dimensional barcode provided on the label surface, wherein at least a portion of the information encoded in the one-dimensional barcode is encoded in the two-dimensional symbol.

9. The identification label of claim 6, wherein the attachment surface comprises an adhesive.

10. The identification label of claim 6 in combination with a book, wherein the identification label is integrated with the book so that a first one-dimensional barcode is optically readable as positioned on the front cover of the book, a second one-dimensional barcode is optically readable as positioned on the rear cover of the book, and the two-dimensional symbol is optically readable as positioned on the spine of the book.
